(19) United States
(12) Patent Application Publication
(10) Pub. No.: US 2014/0220514 A1
(43) Pub. Date: Aug. 7, 2014

(54) GAMES FOR LEARNING REGULATORY BEST PRACTICES

(71) Applicant: Gamxing Inc., Ashburn, VA (US)

(72) Inventors: Katherine Waldron, San Diego, CA (US); Pavan Kumar Ravula Lakshminarayan, San Diego, CA (US)

(73) Assignee: Gamxing Inc., Ashburn, VA (US)

(21) Appl. No.: 14/172,574

(22) Filed: Feb. 4, 2014

Related U.S. Application Data
(60) Provisional application No. 61/760,554, filed on Feb. 4, 2013.
(60) Provisional application No. 61/883,009, filed on Sep. 26, 2013.

(51) Int. Cl. G09B 5/02

(52) U.S. Cl. CPC G09B 5/02
USPC 434/107

(57) ABSTRACT

An apparatus, method, and program product are provided for games for learning regulatory best practices. A display module presents a virtual learning environment for an organization associated with an industry sector. A gaming module presents a game within the virtual learning environment that is designed to train and/or test a user on regulations associated with the industry sector. A management module provides a manager, who is different than the user, access to the game. The manager accesses one or more game settings to customize the game according to the skill level of the user.

### CROSS-REFERENCES TO RELATED APPLICATIONS

This application claims the benefit of U.S. Provisional Patent Application No. 61/760,554 entitled “GAMES FOR LEARNING REGULATORY BEST PRACTICES” and filed on Feb. 4, 2013, for Katherine Waldron, et al., and U.S. Provisional Patent Application No. 61/883,099 entitled “GAMES FOR LEARNING REGULATORY BEST PRACTICES” and filed on Sep. 26, 2013, for Katherine Waldron, et al., which are incorporated herein by reference.

### FIELD

This invention relates to educational software and more particularly relates to gaming software for learning regulatory best practices.

### BACKGROUND

In general, regulations are rules or directives made and maintained by an authoritative body, such as a legislature, governmental agency, etc. In certain industries, it may be necessary for employers and employees to learn the various regulations for a particular industry in order to ensure that business practices conform to certain laws and regulations. However, it may be difficult to learn and remember numerous regulations for an industry, especially when the regulations are revised and updated by the authoritative body.

### SUMMARY

An apparatus for games for learning regulatory best practices is disclosed. A method and program product also perform the functions of the apparatus. In one embodiment, an apparatus includes a display module that presents a virtual learning environment on an electronic display of an electronic device. In some embodiments, the virtual learning environment is for an organization associated with an industry sector.

In another embodiment, an apparatus includes a gaming module that presents a game within the virtual learning environment. In certain embodiments, the game is designed to train and/or test a user on regulations associated with the industry sector. In a further embodiment, an apparatus includes a management module that provides a manager access to the game. In one embodiment, the manager is different than the user. In another embodiment, the manager accesses one or more game settings to customize the game according to the skill level of the user.

An apparatus, in another embodiment, includes a regulation non-compliance module that presents a non-compliance scenario in the game. In one embodiment, the non-compliance scenario includes a virtual presentation of a scenario that violates a regulation associated with the industry sector. In another embodiment, an apparatus includes a non-compliance score module that receives a response from the user and scores the received response. In another embodiment, the user recognizing the violation of the regulation comprises a higher score than the user not recognizing the violation.

In a further embodiment, an apparatus includes a regulation compliance module that presents a compliance scenario in the game. In one embodiment, the compliance scenario includes a virtual presentation of a scenario that demonstrates compliance with a regulation associated with the industry sector. In another embodiment, an apparatus includes a compliance score module that receives a response from the user and scores the received response. In certain embodiments, the user recognizing the compliance with the regulation comprises a higher score than the user not recognizing the compliance.

In one embodiment, an apparatus includes a regulation task module that presents a task scenario in the game. In certain embodiments, the task scenario includes a virtual presentation of a scenario where the user performs a virtual task in compliance with a regulation and/or takes one or more virtual actions to make a scenario compliant with a regulation. In some embodiments, the regulation is associated with the industry sector. In a further embodiment, an apparatus includes a task score module that receives a response from the user and scores the received response. In some embodiments, the user performing the virtual task in compliance with the regulation and/or the user taking one or more virtual actions to make a scenario compliant with the regulation comprises a higher score than the user not performing the virtual task in compliance with the regulation and/or the user not taking one or more virtual actions to make the scenario compliant with the regulation.

In another embodiment, an apparatus includes a regulation interaction module that presents an interaction scenario in the game. In certain embodiments, the interaction scenario includes a virtual presentation of a scenario where the user interacts with a virtual character in compliance with a regulation associated with the industry sector. In another embodiment, an apparatus includes an interaction score module that receives a response from the user and scores the received response. In one embodiment, the user interacting with the virtual character in compliance with the regulation comprises a higher score than the user not interacting in compliance with the regulation.

In one embodiment, an apparatus includes a scoring module that determines a score for the game based on the user's performance in the game. In another embodiment, the score is accessible to the manager of the game. In some embodiments, the one or more game settings comprise game content and game rules. In certain embodiments, a manager adjusts one or more of the game content and game rules based on the user's performance in the game.

In another embodiment, an apparatus includes a reporting module that creates a report based on the user's scores associated with the game. In one embodiment, the report is organized by regulations presented in the game. In certain embodiments, the display module presents a representation of a workplace location. In one embodiment, the workplace location represents a role in the organization and has one or more games tailored to the role. In another embodiment, the one or more games are played in sequence and increase in difficulty in response to the user successfully playing a game.

In a further embodiment, the gaming module modifies one or more game settings in response to the user playing the game such that the user is provided with a different experience each time the game is played. In another embodiment, an apparatus includes a gamification module that provides one or more gamification features for the game. In certain embodiments, the one or more gamification features include virtual life, achievements, leaderboards, and virtual currency.

In another embodiment, an apparatus includes a certification module that provides a certification associated with the industry sector to the user in response to the user successfully playing a game associated with the industry sector. In certain embodiments, the gaming module increases a difficulty of the game in response to a correct response from the user. In another embodiment, the gaming module decreases a difficulty of the game in response to an incorrect response from the user. In certain embodiments, the gaming module manages a competition between a plurality of users playing the game. In certain embodiments, the plurality of users are grouped into a plurality of teams. In one embodiment, a team score is generated by combining individual scores of the plurality of users on a team.

In another embodiment, an apparatus includes a help module that connects the user with a remote user in response to user input. In certain embodiments, the remote user provides the user with information regarding one or more of the regulations. In another embodiment, an apparatus includes a library module that presents one of a text of a regulation, a summary of a regulation, and an interpretation of a regulation to the user in response to user input.

A method is provided that, in one embodiment, includes presenting a virtual learning environment on an electronic display of an electronic device. In some embodiments, the virtual learning environment is for an organization associated with an industry sector. In another embodiment, a method includes presenting a game within the virtual learning environment. In certain embodiments, the game is designed to train and/or test a user on regulations associated with the industry sector. In a further embodiment, a method includes providing a manager access to the game. In one embodiment, the manager is different than the user. In another embodiment, the manager accesses one or more game settings to customize the game according to the skill level of the user.

In one embodiment, a method includes presenting a non-compliance scenario in the game. In one embodiment, the non-compliance scenario includes a virtual presentation of a scenario that violates a regulation associated with the industry sector. In another embodiment, a method includes receiving a response from the user and scoring the received response. In another embodiment, the user recognizing the violation of the regulation comprises a higher score than the user not recognizing the violation.

In one embodiment, a method includes presenting a compliance scenario in the game. In another embodiment, the compliance scenario includes a virtual presentation of a scenario that demonstrates compliance with a regulation associated with the industry sector. In a further embodiment, a method includes receiving a response from the user and scoring the received response. In certain embodiments, the user recognizing the compliance with the regulation comprises a higher score than the user not recognizing the compliance.

In one embodiment, a method includes presenting a task scenario in the game. In certain embodiments, the task scenario includes a virtual presentation of a scenario where the user performs a virtual task in compliance with a regulation and/or takes one or more virtual actions to make a scenario compliant with a regulation. In some embodiments, the regulation is associated with the industry sector. In another embodiment, a method includes receiving a response from the user and scoring the received response. In some embodiments, the user performing the virtual task in compliance with the regulation and/or the user taking one or more virtual actions to make a scenario compliant with the regulation comprises a higher score than the user not performing the virtual task in compliance with the regulation and/or the user not taking one or more virtual actions to make the scenario compliant with the regulation.

In another embodiment, a method includes presenting an interaction scenario in the game. In certain embodiments, the interaction scenario includes a virtual presentation of a scenario where the user interacts with a virtual character in compliance with a regulation associated with the industry sector. In a further embodiment, a method includes receiving a response from the user and scoring the received response. In one embodiment, the user interacting with the virtual character in compliance with the regulation comprises a higher score than the user not interacting in compliance with the regulation.

In another embodiment, a method includes presenting a representation of a workplace location. In one embodiment, the workplace location represents a role in the organization and has one or more games tailored to the role. In certain embodiments, the one or more games are played in sequence and increase in difficulty in response to the user successfully playing a game. In another embodiment, a method includes modifying one or more game settings in response to the user playing the game such that the user is provided with a different experience each time the game is played.

A program product is provided that, in one embodiment, includes a computer readable storage medium that stores code executable by a processor. In one embodiment, the code presents a virtual learning environment on an electronic display of an electronic device. In some embodiments, the virtual learning environment is for an organization associated with an industry sector. In another embodiment, the code presents a game within the virtual learning environment. In certain embodiments, the game is designed to train and/or test a user on regulations associated with the industry sector. In a further embodiment, the code provides a manager access to the game. In one embodiment, the manager is different than the user. In another embodiment, the manager accesses one or more game settings to customize the game according to the skill level of the user.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system for a regulation game;

FIG. 2 is a schematic block diagram illustrating one embodiment of an apparatus for a regulation game;

FIG. 3 is a schematic block diagram illustrating another embodiment of an apparatus for a regulation game;

FIG. 4 is a flow chart diagram illustrating one embodiment of a method for a regulation game;

FIG. 5 is a flow chart diagram illustrating another embodiment of a method for a regulation game;

FIG. 6 is an illustration of one embodiment of an environment for a regulation game;

FIG. 7 is an illustration of one embodiment of a graphical interface for a manager;

FIG. 8 is an illustration depicting one example of a game associated with a regulation;

FIG. 9 is an illustration depicting one example of a game tailored to a specific workplace;

FIG. 10 is an illustration depicting one example of a game associated with a regulation; and

FIG. 11 is an illustration depicting one example of displaying the text of a regulation associated with a game.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer readable medium may be a tangible computer readable storage medium storing the program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable storage medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store program code for use by and/or in connection with an instruction execution system, apparatus, or device.

The computer readable medium may also be a computer readable signal medium. A computer readable signal medium may include a propagated data signal with program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport program code for use by or in connection with an instruction execution system, apparatus, or device. Program code embodied on a computer readable signal medium may be transmitted using any appropriate medium, including but not limited to wire-line, optical fiber, Radio Frequency (RF), or the like, or any suitable combination of the foregoing

In one embodiment, the computer readable medium may comprise a combination of one or more computer readable storage mediums and one or more computer readable signal mediums. For example, program code may be both propagated as an electro-magnetic signal through a fiber optic cable for execution by a processor and stored on RAM storage device for execution by the processor.

Program code for carrying out operations for aspects of the present invention may be written in any combination of one or more programming languages, including an object oriented programming language such as Java, Smalltalk, C++, PHP or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The computer program product may be integrated into a client, server and network environment by providing for the computer program product to coexist with applications, operating systems and network operating systems software and then installing the computer program product on the clients and servers in the environment where the computer program product will function.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and computer program products according to embodiments of the invention. It will be understood that each block of the schematic flowchart diagrams and/or schematic block diagrams, and combinations of blocks in the schematic flowchart diagrams and/or schematic block diagrams, can be implemented by program code. The program code may be provided to a processor of a general purpose computer, special purpose computer, sequencer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The program code may also be loaded onto a computer, other programmable data processing apparatus, or other devices to cause a series of operational steps to be performed on the computer, other programmable apparatus or other devices to produce a computer implemented process such that the program code which executed on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

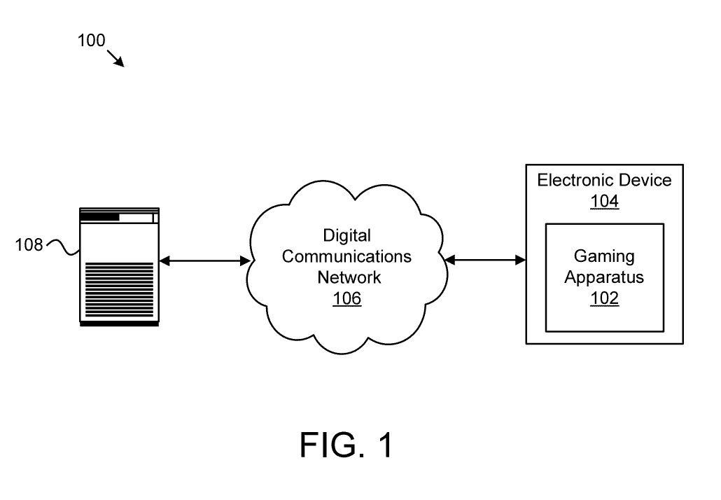

FIG. 1 is a schematic block diagram illustrating one embodiment of a system 100 for a regulation game. The system 100 includes a gaming apparatus 102, an electronic device 104, a digital communication network 106, and a server 108, which are described below.

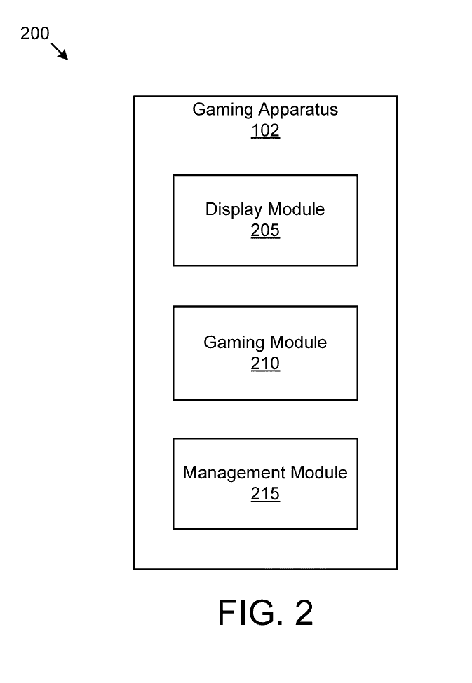

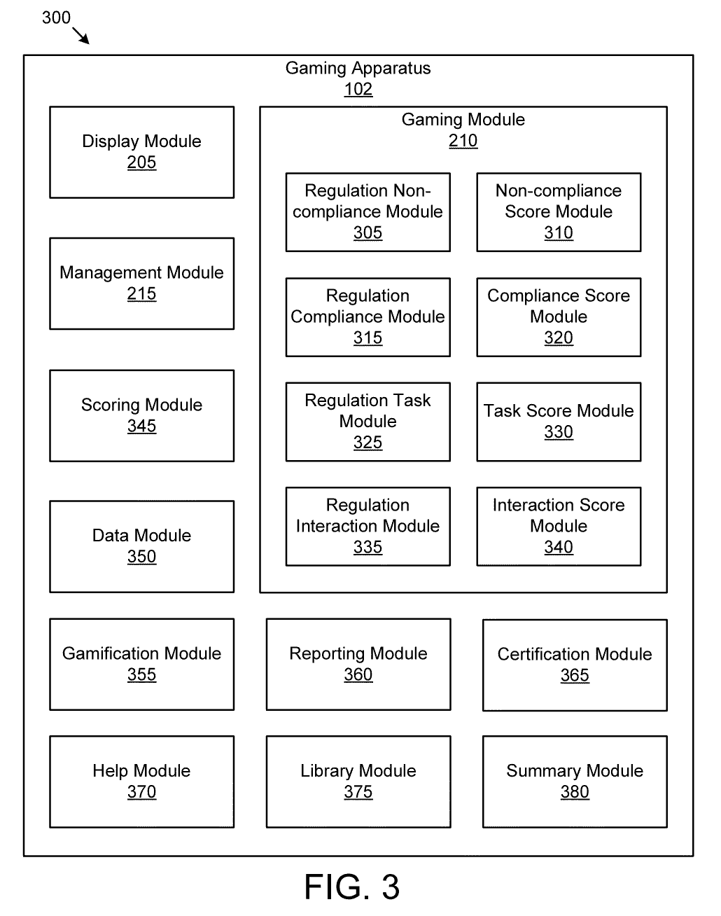

In one embodiment, the gaming apparatus 102 presents a virtual learning environment on an electronic display of an electronic device 104. The virtual learning environment, in another embodiment, is associated with an organization in an industry sector. In a further embodiment, the gaming apparatus 102 presents games within the virtual learning environment that assist in training and testing a user on regulations associated with the organization's industry. In some embodiments, the gaming apparatus 102 provides access to the game settings to a manager, who is different than the user and can customize the games according to a skill level of the user. In one embodiment, the gaming apparatus 102 includes one or more modules that perform the operations of the apparatus 102. The gaming apparatus 102, including its associated modules, will be explained in more detail below with reference to FIGS. 2 and 3.

In one embodiment, the electronic device 104 includes a desktop computer, a smart phone, a server, a laptop computer, a tablet computer, a mainframe computer, a blade center, and/or any other electronic device 104 capable of displaying a graphical virtual learning environment. In another embodiment, the electronic device 104 includes a wearable device, such as a smart watch, an optical head-mounted display unit, and/or the like. In one embodiment, at least a portion of the gaming apparatus 102 is located on an electronic device 104. In another embodiment, at least a portion of the gaming apparatus 102 is located on a server 108.

In certain embodiments, an electronic device 104 includes an electronic display that is capable of presenting a graphical virtual learning environment, which may be presented in two and/or three dimensions. In another embodiment, the electronic display includes a touch-enabled display, which a user uses to interact with the virtual learning environment. In another embodiment, the electronic device 104 communicates with a server 108 through a digital communication network 106. In some embodiments, the electronic device 104 accesses information associated with a virtual learning environment from the server 108, such as user data, scores, statistics, regulation games, regulatory information, and/or the like. In certain embodiments, the electronic device 104 stores information associated with a virtual learning environment on the server 108, such as user data, game statistics, and/or the like.

The system 100 includes a digital communication network 106 that transmits digital communications related to a regulation game. The digital communication network 110 may include a wireless network, such as a wireless telephone network, a local wireless network, such as a Wi-Fi network, a Bluetooth® network, and the like. The digital communication network 110 may include a wide area network (“WAN”), a storage area network (“SAN”), a local area network (“LAN”), an optical fiber network, the internet, or other digital communication network known in the art. The digital communication network 110 may include two or more networks. The digital communication network 110 includes one or more servers, routers, switches, and other networking equipment. The digital communication network 110 may also include computer readable storage media, such as a hard disk drive, an optical drive, non-volatile memory, random access memory (“RAM”), or the like.

The server 108, in one embodiment, includes a desktop computer, a smart phone, a laptop computer, a tablet computer, a mainframe computer, a blade center, and/or the like. In certain embodiments, the server 108 includes a cloud server, which the electronic device 104 communicates with over a digital communications network 106 such as the Internet. For example, a virtual learning environment may be executed on the server 108 and accessed by the electronic device 104 through the “cloud.” In one embodiment, the gaming apparatus 102 may include elements on both the electronic device 104 and the server 108. In one embodiment, a user interacts with the electronic device 104 and/or the server 108 using an input device, such as a mouse, keyboard, and/or a touch enabled device.

FIG. 2 is a schematic block diagram illustrating one embodiment of an apparatus 200 for a regulation game that includes an embodiment of a gaming apparatus 102. The gaming apparatus 102, in certain embodiments, may include a display module 205, a gaming module 210, and a management module 215, which are described below.

The apparatus 200, in one embodiment, includes a display module 205 that presents a virtual learning environment on an electronic display of an electronic device 104. The virtual learning environment may include a representation of a workplace layout for an organization associated with an industry sector where employees must follow industry regulations. In other embodiments, the virtual learning environment includes a representation of a shop, a plant, a factory, a hospital, a clinic, a home, or any other worksite where employees are required to follow industry regulations. The virtual learning environment may include a workbench, a laboratory, a paint booth, an assembly line, a hospital room, a reception desk, a construction site, or other location where employees are required to perform duties that are compliant with industry regulations.

Industry regulations may include governmental regulations, federal regulations, state regulations, regulations of a safety organization, company regulations, or other regulations that employees are required to comply with during normal execution of the employees' duties. For example, the industry sector may include healthcare and the regulations may include healthcare regulations, such as regulations associated with the Healthcare Insurance Portability and Accountability Act of 1996 (“HIPAA”). In another embodiment, the regulations may include regulations enforced by the Occupational Safety and Health Administration (“OSHA”). In another embodiment, the regulations may be those enforced by the Mine Safety and Health Administration (“MSHA”). In another embodiment, the regulations may be regulations developed and enforced by an employer. One of skill in the art will recognize other regulations where scenarios may be presented in a virtual learning environment on an electronic display with a representation of the scenario such that an employee may recognize compliance and violations of regulations for training purposes.

In one embodiment, the display module 205 presents a three-dimensional representation of a workplace within the virtual learning environment, such that the workplace representation visually includes length, width, and depth perspectives. For example, in a three-dimensional perspective of a lab, a user represented by a virtual character, such as an avatar, may appear to move around the three-dimensional lab as if the user were in the lab. In another embodiment, the user may move around the three-dimensional workplace from a first-person perspective without using a virtual character such that it appears the user is moving around the workplace. In other embodiments, the display module 205 presents a representation of a workplace from a two-dimensional perspective within the virtual learning environment, where only length and width perspectives are presented.

The display module 205, in one embodiment, presents a representation of one or more workplace locations such that each workplace location of the one or more workplace locations represents a role in the organization. For example, the workplace location may be an office and the office layout may present offices representing a waiting room, an information technology (“IT”) room, a doctor's office, a medical records room, a treatment room, a lab room, and/or the like. In certain embodiments, the one or more workplace locations may include one or more games presented by the gaming module 210 that are tailored to the role in the organization. Thus, for example, an employee that works in a lab would enter the virtual lab room to play a game that would train and/or test their knowledge of healthcare regulations as related to the lab environment.

The apparatus 200, in another embodiment, includes a gaming module 210 that presents one or more games within the virtual learning environment that are designed to train and/or test a user on regulations associated with an industry sector. For example, a game may be designed to teach a user about regulations in industry sectors such as healthcare, finance, government, and/or the like. In another embodiment, a game may be designed as a test to assess a user's knowledge and competency with industry sector regulations. In another embodiment, the gaming module 210 may present one or more games associated with multiple industry sector regulations. For example, the gaming module 210 may present regulations associated with OSHA and HIPAA. In one embodiment, the regulations associated with the industry sector comprise one or more of cyber-security and social networking regulations.

The one or more games, in various embodiments, may include many different game types, including, but not limited to, concept games, sequence games, social games, or the like. Concept games may include games that focus on a specific regulation. In one example, a game may focus on a definition of a business associate, and may require less time to complete. For example, a concept game focused on a definition of a term may take less than five minutes to complete. Concept games, in other embodiments, may include different difficulties or may require a user to complete one game before advancing to other games and/or concepts.

In one embodiment, a game may include a sequence game. A sequence game, may provide multiple events in a sequence, each event associated with a specific regulation. In one example, a sequence game may include 8-10 events depicting various scenes at an accounting firm, of course, this disclosure is not limited in this regard as any number of events may be included in a sequence game. Sequence games may focus on actual case studies and may describe interpretations of regulations for the associated regulations. In other embodiments, sequence games may address both security and privacy regulatory events.

In another embodiment, the one or more games associated with the one or more workplace locations may include multiple levels where each level may be played in sequence and increase in difficulty in response to a user successfully completing a level. The gaming module 210, in one embodiment, changes the content and/or rules of the one or more games each time a user re-enters a game in order to provide the user with a different training experience each time a game is played. In another embodiment, the gaming module 210 provides one or more hints to a user playing a game. In some embodiments, the content of the hints may be determined by a manager.

In another embodiment, the one or more games associated with the one or more workplace locations may include multiple difficulty levels where the difficulty level may be adjusted based on responses by a user. Therefore, in certain embodiments, the gaming module 210 may adapt the one or more games based on responses from the user. In one embodiment, the gaming module 210 may increase the difficulty level of the games in response to correct responses from the user. In another embodiment, the gaming module 210 may decrease the difficulty level of the games in response to incorrect responses from the user. In one example, a user may respond correctly three times in a row, and the gaming module 210 may increase a difficulty level of the current game. In another example, a user may respond incorrectly two times in a row, and the gaming module 210 may decrease a difficulty level of the current game. Increasing difficulty, in one embodiment, includes the gaming module 210 increasing difficulty of regulatory learning. For example, the gaming module 210 may increase difficulty of questions. In another example, the gaming module 210 may include scenarios where a regulatory violation is more difficult to detect or is more subtle. In some embodiments, questions presented by the gaming module 210 are unique to a game such that questions presented in one game are not presented in a different game.

The apparatus 200, in one embodiment, includes a management module 215 that provides access to the one or more games by a manager. In some embodiments, the manager is a different person than the user playing the game. The management module 215, in some embodiments, provides the manager access to the settings of the one or more games such that the manager may customize the game according to the skill level of the user playing the game. In one embodiment, the manager may set the difficulty level of the game, the amount of time the user has to play the game, the rules of the game, the regulations to be tested, and/or the like. For example, a hospital manager may have access to the settings of a game designed to test a lab employee on healthcare regulations in a hospital lab environment. The hospital manager may customize the game settings to test specific healthcare regulations associated with lab employees, such as properly securing lab results and/or lab specimens, properly disposing of lab material, and/or the like.

In one embodiment, a user does not have the same management control over a game and/or access to scores as a manager. For example, a manager may access a user's scores in order to assess a user's understanding of the industry sector regulations and may adjust the one or more games accordingly. In one embodiment, the manager is a third party representative not employed within the organization associated with the regulation games. For example, an organization may work with a testing center that administers one or more regulation games to the organization's employees. The management module 215, in one embodiment, provides the testing center manager and/or representative access to game settings and/or game scores associated with the user. In another embodiment, the management module 215 automatically notifies a manager in response to a user completing one or more games, beginning one or more games, modifying settings for one or more games, changes in difficulty for the user, or the like. In certain embodiments, the management module 215 sends notifications via email, text messages, automated voice calls, and/or the like.

FIG. 3 is a schematic block diagram illustrating another embodiment of an apparatus 300 for a regulation game. In one embodiment, the apparatus 300 includes an embodiment of a gaming apparatus 102. The gaming apparatus 102, in certain embodiments, includes a display module 205, a gaming module 210, and a management module 215, which are substantially similar to the display module 205, the gaming module 210, and the management module 215 described above with reference to FIG. 2.

In various embodiments, the gaming module 210 of the apparatus 300 includes a regulation non-compliance module 305, a non-compliance score module 310, a regulation compliance module 315, a compliance score module 320, a regulation task module 325, a task score module 330, a regulation interaction module 335, and an interaction score module 340, which are described below. Further, the apparatus 300, in various embodiments, includes a scoring module 345, a data module 350, a gamification module 350, a reporting module 360, a certification module 365, a help module 370, a library module 375, and a summary module 380, which are described in more detail below.

The gaming module 210, in one embodiment, includes a regulation non-compliance module 305 that presents a non-compliance scenario to the user. The non-compliance scenario may include a virtual depiction of a scenario that violates a regulation associated with an industry sector. A non-compliance score module 310 may receive a response from the user and score the response of the user such that a user that recognizes the violation of the regulation receives a higher score than a user that does not recognize the violation.

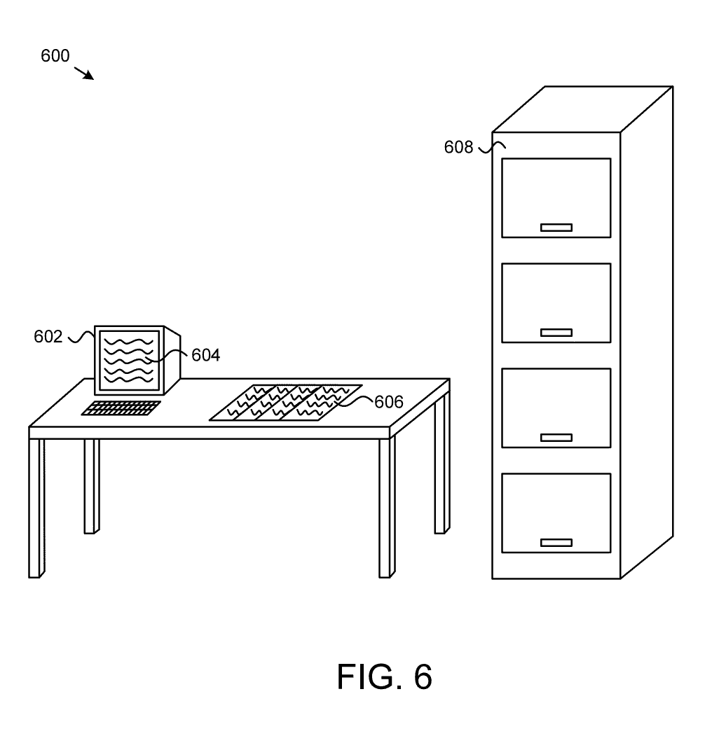

For example, a user may be presented with a gaming scenario by the regulation non-compliance module 305, such as the scenario depicted in FIG. 6, which violates one or more industry sector regulations. In order to earn points, a user may need to recognize elements of the gaming scenario that violate industry regulations. The user may need to recognize, for example, that the computer 602 may not be properly secured, allowing unauthorized users access to programs 604 running on the computer, or that confidential documents 606 are left out instead of securely locked in a filing cabinet 608.

In one embodiment, the user may have a limited amount of time to recognize violations within the scenario. In certain embodiments, the non-compliance score module 310 scores a response according to how quickly the user responds. For example, a user who provides a correct answer in five seconds will receive a higher score than a user who provides a correct answer in ten seconds. The non-compliance score module 310 may score the user's responses and provide a user with an overall score for the scenario. In a testing situation, a manager may access the scores to assess the user's mastery of the tested regulations and may adjust the content of the regulation game according to the user's performance.

In certain situations, employees of an organization in a workplace environment may not follow one or more regulations, therefore training may be used to encourage compliance. In order to address a specific behavior that is inconsistent with a current set of regulations, in one embodiment, a regulation non-compliance module 305 may receive a custom scenario to be included in the one or more of the games. The custom scenario may be associated with the rule or regulation the employees may not have been following. The gaming module 210 may integrate the new custom scenario into a game. In another embodiment, the gaming module 210 may prioritize the games such that the new custom scenario is presented more frequently than other games in the one or more games. The custom scenario may be transmitted to the gaming module 210 via the Internet, via a service, via a message, or the like. One skilled in the art may recognize other ways to transmit information electronically and this disclosure is meant to cover all such methods.

In one example, employees of a health organization may refuse to provide medical records to a patient against HIPAA requirements. A regulation non-compliance module 305 may receive a new custom scenario via email to a manager of the health organization to address this specific problem. The new custom scenario may depict a three dimensional representation of a scenario where an employee refuses to provide medical records. The new custom scenario may be more effective at instructing employees of the health organization under which circumstances a patient may receive a copy of his/her medical records. In another embodiment, the new custom scenario is presented in a gaming situation as a question, a non-compliance situation, or other method of teaching a user so that the user can earn points, credits, etc. to continue with the game, extend life, etc.

In another embodiment, a court, or other precedential organization may interpret one of the regulations in a different way than previously interpreted. In one embodiment, the management module 215 may adjust one or more settings of one or more of the games to include the new interpretation of one of the regulations.

In another embodiment, the gaming module 210 includes a regulation compliance module 315 that presents a compliance scenario to the user. The compliance scenario may include a virtual depiction of a scenario that demonstrates compliance with a regulation associated with the industry sector. A compliance score module 320 may receive a response from the user and score the response of the user such that the user recognizing the compliance with the regulation comprises a higher score than the user not recognizing the compliance.

For example, a user may be presented with a gaming scenario by the compliance module 315, such as the scenario depicted in FIG. 6, which demonstrates compliance with one or more industry sector regulations. In order to earn points, a user may need to recognize elements of the gaming scenario that comply with industry regulations. The user may need to recognize, for example, that the computer 602 is properly secured, such that unauthorized users cannot access programs 604 running on the computer, or that confidential documents 606 are securely locked in a filing cabinet 608.

In one embodiment, the user may have a limited amount of time to recognize compliance elements within the scenario. In certain embodiments, the compliance score module 320 scores a response according to how quickly the user responds. For example, a user who provides a correct answer in five seconds will receive a higher score than a user who provides a correct answer in ten seconds. The compliance score module 320 may score the user's responses and provide a user with an overall score for the scenario. In a testing situation, a manager may access the scores to assess the user's mastery of the tested regulations and may adjust the content of the regulation game accordingly.

In one embodiment, the gaming module 210 includes a regulation task module 325 that presents a task scenario to the user. The task scenario may include a virtual depiction of a scenario where the user performs a virtual task in compliance with a regulation and/or takes one or more virtual actions to make a scenario compliant with a regulation associated with the industry sector. A task score module 330 may receive a response from the user and score the response of the user such that the user performing the virtual task in compliance with the regulation and/or the user taking one or more virtual actions to make a scenario compliant with the regulation comprises a higher score than the user not performing the virtual task in compliance with the regulation and/or the user not taking one or more virtual actions to make the scenario compliant with the regulation.

For example, a user may be presented with a gaming scenario by the regulation task module 325, such as the scenario depicted in FIG. 6, where a user may earn points by performing a virtual task and/or performing one or more virtual actions to bring a scenario into compliance with industry sector regulations. The computer 602, for example, may not be properly secured, such that unauthorized users have access programs 604 running on the computer. To earn points, the user may need to go through the steps of securing the computer 602. Alternatively, a user may earn points by securely locking the confidential documents 606 in a filing cabinet 608. Other examples may include sending a compliant email, properly disposing of documents, faxing documents, and/or the like.

In one embodiment, the user may have a limited amount of time to perform the regulation compliant virtual task and/or virtual actions. In certain embodiments, the task score module 330 scores a response according to how quickly the user responds. For example, a user who performs the regulation compliant virtual tasks and/or virtual actions in five seconds will receive a higher score than a user who performs the regulation compliant virtual tasks and/or virtual actions in ten seconds. The task score module 330 may score the user's responses and provide a user with an overall score for the scenario. In a testing situation, a manager may access the scores to assess the user's mastery of the tested regulations and may adjust the content of the regulation game accordingly.

The gaming module 210, in another embodiment, includes a regulation interaction module 335 that presents an interaction scenario to the user. The interaction scenario may include a virtual presentation of a scenario where the user interacts with a virtual character in compliance with a regulation associated with the industry sector. An interaction score module 340 may receive a response from the user and score the response of the user such that the user interacting with the virtual character in compliance with the regulation comprises a higher score than the user not interacting in compliance with the regulation.

For example, a user may be presented with a gaming scenario by the regulation interaction module 335 where a user may earn points by interacting with a virtual character in compliance with an industry regulation. The virtual character, for example, may ask the user one or more questions and the user may earn points for providing regulation compliant responses. Alternatively, the user may earn points by interacting with a voice mail system, an intercom system, and/or the like, in compliance with industry sector regulations. The interaction score module 340 may score the user's responses and provide a user with an overall score for the scenario. In a testing situation, a manager may access the scores to assess the user's mastery of the tested regulations and may adjust the content of the regulation game accordingly.

In one embodiment, the apparatus 300 includes a scoring module 345 that determines a score for a game played by the user based on the user's performance in the game. In one embodiment, the game includes a game of the one or more games provided by the gaming module 210. In another embodiment, the management module 215 provides access to a manager to access scores of one or more games played by a user. In another embodiment, the scoring module 345 may aggregate scores of multiple games to provide a user with an overall score.

In another embodiment, the scoring module 345 may collect and store users scores of the one or more games in a computer readable storage medium, such as a database, located on the server 108. The scoring module 345, in another embodiment, provides access to the scores by the management module 215. A manager may, for example, access scores located on the server 108 through the digital communication network 106. In another embodiment, the scoring module 345 may publish scores for one or more games to a social network. For example, the scoring module 345 may publish scores via a posted message on a social network server, such as, but not limited to, Facebook®, Twitter®, MySpace®, or the like.

In another embodiment, a game may include a social game. A social game may include multiple users and a scoring module 345 may combine scores and/or responses for the users. In other embodiments, a social game may include multiple teams where each team includes multiple users, the scoring module 345 tracking scores for respective teams. Team members, in one embodiment, may collaborate to assist other team members with regulatory learning situations, such as answering questions, recognizing violations, recognizing applicable regulations, etc. In another embodiment, the display module 205 may display the results for the teams. In another embodiment, results of a social game may be posted via a social networking server. Posting results of a social game publicly may enhance competition between users of the one or more games. In one embodiment, the display module 205 may display results of two or more games on the electronic display. In another embodiment, the scoring module 345 may combine scores for users of respective teams to generate team scores.

The apparatus 300, in some embodiments, may include a data module 350 that collects and stores usage statistics and other relevant information associated with a user playing the one or more games. For example, the data module 350 may track how long a user played a game, how many times a user played a game, and/or the like. In one embodiment, the data may be stored on a computer readable storage medium, such as a database, located on the server 108. In another embodiment, the data located on the server 108 may be accessible to a manager, through the management module 215, over the digital communication network 106. In one embodiment, a reporting module 360 creates one or more reports based on the data and/or scores of a user playing the one or more games. A manager may, for example, incorporate the data collected by the data module 350 into a report and may also customize the content and/or layout of the report.

In one embodiment, the reporting module 360 provides a graphical representation of results of a game. In one embodiment the results indicate understanding of the regulations presented in the game. In one embodiment, the graphical representation includes graphs, charts, tables, lists, and/or the like that visually describe the results of a game. In certain embodiments, a management module 215 provides access to the graphical representation of the results. In certain embodiments, the reporting module 360 provides results for a single game, a plurality of games, a regulation, a plurality of regulations, a user, a plurality of users, an organization, and/or the like. For example, a manager may view results from HIPAA compliance tests for a user, a group of users, and/or an entire organization. Alternatively, the manager may view results associated with particular HIPAA regulations to determine whether individuals, groups, or the organization is compliant with particular regulations.

In another embodiment, the indication of understanding of the regulations includes compliance, non-compliance, or the like. In another embodiment, the reporting module 360 generates a compliance score that indicates understanding of the regulations. In one embodiment, the compliance score is generated based on the user's performance in a game. For example, the user may earn points for correctly understanding compliance and/or non-compliance issues. Alternatively, the compliance score may be determined based on scores provided by the non-compliance score module 310, the compliance score module 320, the task score module 330, and the interaction score module 340. In certain embodiments, the compliance score is presented on a sliding scale that represents different levels of understanding of the regulations. For example, a user that receives a compliance score of 90 may be considered in compliance, but a user that receives a compliance score of 30 may be considered in non-compliance with a regulation. In certain embodiments, the sliding scale includes a compliance threshold value such that compliance scores above the threshold value are considered in compliance and compliance scores below the threshold value are considered non-compliant with a regulation.

In another embodiment, the compliance score includes a percentage of games successfully played by a user. In certain embodiments, a successfully playing a game includes the user demonstrating compliance with a predetermined number of regulations in the game. In another embodiment, the compliance score is associated with a game and includes a percentage of a number of regulations correctly understood in the game. In one embodiment, the reporting module 360 presents a compliance score for each regulation presented in a game. In some embodiments, the reporting module 360 organizes the results according to the compliance scores of the regulations. In some embodiments, the reporting module 360 aggregates a plurality of compliance scores associated with users associated with an organization playing a game such that an aggregate compliance score for a regulation may be generated.

In another embodiment, the reporting module 360 determines the frequency with which a regulation is correctly and/or incorrectly understood and presents the frequency as part of the results. In another embodiment, the reporting module 360 organizes the results by the users associated with the organization such that the users are presented in order of compliance score for a regulation, a game, a plurality of games, or the like. For example, a manager may use such a report to determine which employees need extra help with understanding a particular regulation or set of regulations. In another embodiment, the reporting module 360 determines the frequency with which the user requests help from a remote user for a regulation and factors the frequency into the compliance score.

The apparatus 300, in another embodiment, includes a gamification module 355 that adds gamification features to the one or more games presented by the gaming module 210. In one embodiment, the gamification features may include virtual life, achievements, leaderboards, and/or virtual currency. In one embodiment, a user may be given a predetermined amount of “life,” which may be reduced for each wrong answer the user provides while playing a game. Alternatively, a user may earn “life” by completing virtual tasks successfully, performing virtual tasks in less time, providing correct responses, and/or the like.

In one embodiment, a user may exchange “life” for hints to help the user successfully complete a regulation game. In another embodiment, an amount of gamification features may be awarded to a user based on a difficulty of the current game. In one example, a simple question at a beginning of a game may result in a single life point. In another example, a difficult question involving more than one regulation may result in many life points being awarded to the user. Furthermore, in another example, responding incorrectly to a simple question involving an interpretation of a term may result in more severe penalties than providing an incorrect response to a more difficult question.

In other embodiments, a user may gain virtual currency by providing correct answers, completing a number of games, performing regulation compliant tasks, and/or the like. In one embodiment, a user may exchange virtual currency for hints, tools, items, virtual prizes, additional “life,” access to more games, and/or the like. In another embodiment, the gamification module 355 connects to a social media network, such as Facebook® or Twitter®, and allows the user to post their scores, achievements, and/or the like. A user, in other embodiments, may also see what other players have scored in their region, industry, organization, and/or the like. In another embodiment, a user may make in-game purchases using real currency to gain additional “life,” hints, items, tools, and/or the like to help the user successfully complete a regulation game.

In one embodiment, the apparatus 300 includes a certification module 365 that provides a certification to a user. In certain embodiments, a user earns a certificate associated with an industry sector by successfully playing a predetermined number of games associated with the industry sector. For example, successfully playing a predetermined number of games may include scoring above a particular level for each game. In another embodiment, the certification module 365 provides one or more continuing education credits to a user in response to a user successfully playing one or more games provided by the gaming module 210. In some embodiments, a user earns a puzzle piece for every game a user successfully completes, such that the user receives a certificate when all the puzzle pieces have been earned. One of skill in the art will recognize other ways for a user to earn a certification.

In one embodiment, the apparatus 300 includes a help module 370 that displays a help selection mechanism on the electronic display. The help selection mechanism, in another embodiment, connects the user with a remote user. The remote user may provide the user with information regarding one or more of the regulations. In certain embodiments, the remote user presents text for a regulation on the electronic display of the electronic device in response to the user interacting with the help selection mechanism. In one embodiment, the help module 370 displays a button, a menu item, or the like to the user.

The help selection mechanism may cause the management module 215 to connect the user to a remote user. In another embodiment, the remote user is knowledgeable with regard to regulations presented by the gaming module 210 and the management module 215 may receive advice, instruction, direction, guidance, interpretation, or other information relative to the regulations from the remote user. In certain embodiments, the remote user is associated with an organization's compliance department. For example, the user may ask questions or request information from a compliance officer within the user's organization by email, text, chat, voice call, or the like in response to interacting with the help selection mechanism. In one embodiment, the gaming module 210 may pause the game in response to the user pressing the help selection mechanism. Also, the gaming module 210 may continue the game in response to the user pressing the help selection mechanism or restarting by another means.

In some embodiments, a timer for the game is paused while the user communicates with the remote user. In another embodiment, a timer for the game may continue to measure time while the user is communicating with the remote user. In certain embodiments, a game includes two timers. A first timer, in one embodiment, measures the total time spent in the game, including time communicating with the remote user, reviewing regulation text and summaries, or the like. A second timer, in certain embodiments, measures just the time spent playing the game. In this manner a manager may determine the total time an employee spent in a training game, how much of that time was review time, and how much was playing the game.

In some embodiments, the measured time is incorporated into a user's score. For example, a user may receive a higher score for spending less time in a game and may receive a lower score for spending more time in a game. The remote user may assist the user in understanding regulations associated with the current game. In one example, the remote user may be a manager that is local to the electronic device or a manager of the user. In another example, the remote user may be a certified subject matter expert for the industry sector associated with a regulation. Of course, other individuals may be remote users, and may include any individuals with sufficient understanding of the associated regulation to provide assistance to the user.

In one embodiment, the communication with the remote user may be real-time, such as with an audio connection, a video stream, or the like. In another embodiment, the communication with the remote user may be based on asynchronous messages transmitted between the user and the remote user. In some embodiments, a reporting module 360 reports the frequency with which the user requests help for an associated regulation.

In one embodiment, a gaming module 210 maintains a library of games and/or regulations associated with one or more industry sectors. The apparatus 300 may include a library module 375 that displays a library selection mechanism on the electronic display. The library selection mechanism connects the user to the library with information about the one or more regulations. The library selection mechanism, in various embodiments, may include a button, a command, a menu item, and/or the like. Respective games in the library may be associated with a specific regulation and may reference specific regulation numbers, related news articles, government positions, interpretations, case studies, or the like. In one example, a game may be associated with HIPAA Rule #164.312(a)(1)(iii), and a response from a user may include a response compliant with HIPAA Rule #164.312(a)(1)(iii). In one embodiment, the reporting module 360 presents a frequency with which the user requests information for an associated regulation.

In another embodiment, a library module 375 may display a button to the user, wherein the button causes the library module 375 to present one of a text of a regulation, a summary of a regulation, and an interpretation of a regulation. In one example, the button may cause an entire text of a regulation to be displayed to the user. In another example, a recent interpretation of a regulation may have been published by a precedential entity for the industry sector, and the library module 375 may display the interpretation in response to the user pressing the button. In another embodiment, the library module 375 presents information comprising text for a regulation in response to the user interacting with a help selection mechanism.

In certain embodiments, the library module 375 presents one or more slide presentations, such as a PowerPoint® presentation, within a game. In another embodiment, the slide presentation is associated with one or more regulations presented in the game. In one embodiment, the library module 375 presents the slide presentation in response to user input, such as a user clicking a button, menu item, or the like. In another embodiment, the library module 375 determines how often a slide presentation is requested, how much time a user spends reviewing a slide presentation, and/or the like, which may be factored in to the user's score for the game.

In one embodiment, the library of games may be stored on a remote server and may be updated regularly based on published articles, opinions, changes to the regulations, or the like. In this embodiment, a gaming module 210 may retrieve games from the server at regular intervals so that games used by the gaming module 210 may stay synchronized with the remote server. In another embodiment, multiple gaming modules 210 may communicate with the remote server. Therefore, a single update to the remote server may allow the multiple gaming modules 210 to stay current.

In one embodiment, a management module 215 may search for games based on any one or more of a regulation, a theme, a concept, a key word, a category, or the like. In another embodiment, various events of games may be tagged with one or more of the regulations, themes, concepts, key words, categories, or the like. In one example, a manager for a hospital may desire games focused on regulations associated with using a facsimile machine. In response to the desire of the manager, a management module 215 may search the library of games for games associated with a key word “fax.” In response to the games associated with the key word, a gaming module 210 may include the games in the virtual learning environment.

In another embodiment, the apparatus 300 includes a summary module 380 that displays a summary selection mechanism on the electronic display. The summary selection mechanism connects the user to a summary of one or more of the regulations. The summary selection mechanism may be a button, command, menu item, selectable item, and/or the like. In some embodiments, the summary module 380 presents a summary of a regulation in response to the user interacting with a help selection mechanism.

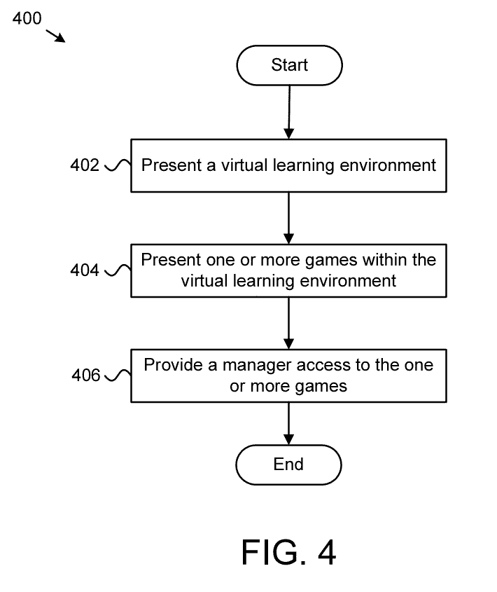

FIG. 4 is a flow chart diagram illustrating one embodiment of a method 400 for a regulation game. In one embodiment, the method 400 begins and presents 402 a virtual learning environment on an electronic display of an electronic device 104. In one embodiment, the virtual learning environment is a representation of an organization's workplace layout. The organization may be associated with an industry sector. In another embodiment, a display module 205 presents the virtual learning environment on an electronic display of an electronic device 104.

The method 400, in some embodiments, presents 404 one or more games within the virtual learning environment. In one embodiment, the one or more games may be designed to train and/or test a user on regulations associated with the organization's industry sector. In certain embodiments, a gaming module 210 may provide the one or more games within the virtual learning environment presented by the display module 205. The method 400, in another embodiment, provides 406 a manager access to the one or more games. A manager, in one embodiment, may change the settings of a game, which may include the content and/or rules of a game, in accordance with the skill level of a user playing a game. In one embodiment, a management module 215 provides a manager access to the one or more games presented by the gaming module 210, and the method 400 ends.

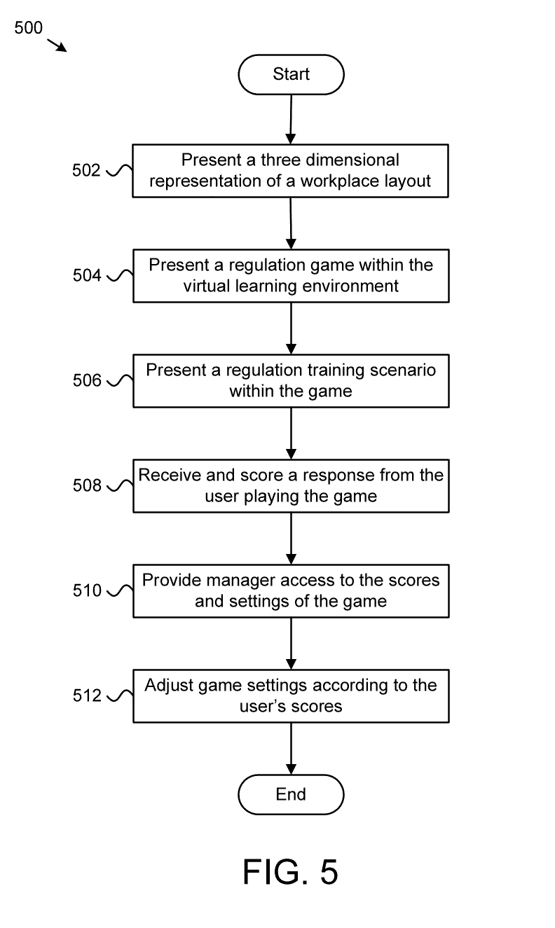

FIG. 5 is a flow chart diagram illustrating another embodiment of a method 500 for a regulation game. The method 500 begins and presents 502 a virtual learning environment representing a workplace layout for an organization. In one embodiment, a display module 205 presents the virtual learning environment on an electronic display of an electronic device 104. A regulation game may be presented 504 within the virtual learning environment, such that a user may be trained and/or tested on industry sector regulations associated with the organization by playing the regulation game. In one embodiment, a gaming module 210 may present the regulation game within the virtual learning environment.

In one embodiment, the method 500 presents 506 a training scenario within the regulation game to train and/or test a user on specific industry sector regulations associated with the organization. In certain embodiments, the training scenario may be presented by a regulation non-compliance module 305, a regulation compliance module 315, a regulation task module 325, a regulation interaction module 335, or the like. In other embodiments, a manager may control the content of the training scenario in order to train and/or test a user on particular regulation issues and to assess the user's knowledge of the industry sector regulations. In one embodiment, the difficulty of the training scenario may increase as a user successfully completes one or more regulation games.

The method 500, in one embodiment, receives 508 a user's responses to the training scenario, and for example, may provide a player with a score according to the user's responses. In one embodiment, a user may earn points for providing correct answers. In another embodiment, a non-compliance score module 310, a compliance score module 320, a task score module 330, and/or an interaction score module 340 scores a user's responses and provides a user with an overall score for a training scenario.

The method 500, in a further embodiment, provides 510 a manager access to a user's scores related to one or more regulation games played by the user. In one embodiment, a scoring module 345 may aggregate and organize scores for a user and may provide a manager access to a user's scores through a management module 215. The method 500, in certain embodiments, adjusts 512 the settings of a regulation game according to the user's scores. In one embodiment, a management module 215 provides a manager access to game settings, which allows a manager to adjust the settings of the game according to the user's mastery of industry sector regulations as evidenced by the user's scores. The game settings, in some embodiments, may include the game rules, the regulations being tested, and/or the training scenario environment, and the method 500 ends.

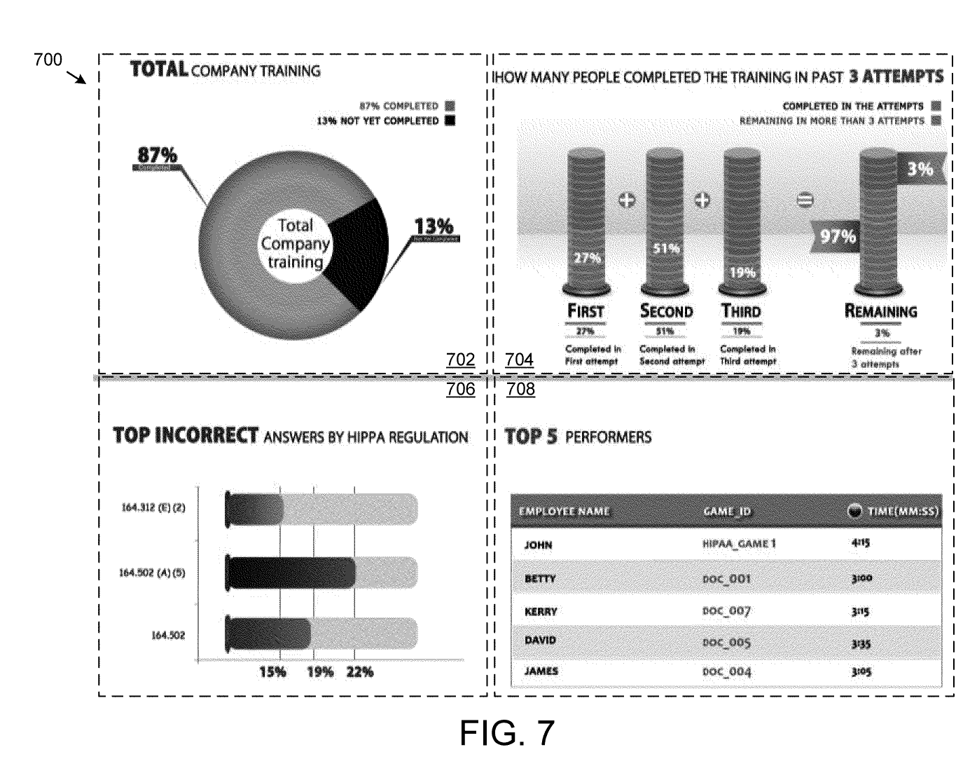

FIG. 7 is an illustration of one example of a graphical interface 700 for a manager. In one embodiment, the reporting module 360 provides a graphical representation of results of a game presented by the gaming module 210, such as testing and/or training results. The results indicate understanding of the regulations and the results may be organized by regulation to display which regulations are tested by the gaming module 210 and scoring of a tested regulation by the user. In some embodiments, the graphical representation of the results indicates a success rate associated with a regulation. For example, the graphical representation may show that 19% of users incorrectly answered questions regarding HIPAA regulation #164.312(E). In certain embodiments, the management module 215 provides a manager access to the graphical representation of the results. In certain embodiments, the manager may customize the graphical representation by selecting the data to be used, the content to be presented, the layout of the graphical representation, and/or the like.

In another embodiment, the reporting module 360 may present a graphical interface 702 that depicts a total number of users that have completed one or more games in the virtual environment. In certain embodiments, the users are associated with an organization. A reporting module 360 may present a percentage of users that have completed a predetermined amount of games in a variety of different graphs. In one example, the percentage may be depicted in a pie chart graph, a bar chart graph, or the like.

In another embodiment, a reporting module 360 may present an interface 704 depicting the number of people completing an event, a sequence of events, steps, questions, or the like of a particular game or games. The reporting module 360 may depict how many attempts at a particular game each user has attempted, or may depict percentages of which users passed training associated with a game in a certain number of attempts, or other information that may present the progress of multiple users playing the one or more games.

In another embodiment, a reporting module 360 may create a report 706 depicting a frequency with which responses are selected by users. In some embodiments, the responses are organized by an associated regulation. For example, the reporting module 360 may create a report that depicts the most frequent incorrect responses. In another example, the reporting module 360 may create a report that depicts regulations associated with games where the users performed most poorly.

In another embodiment, a reporting module 360 may create a report 708 based on the users' scores associated with the game. For example, the report 708 may depict top scores by users of the one or more games. In another example, a reporting module 360 may create a report that identifies the top five users and their top scores for one or more of the games in the virtual learning environment. The reporting module 360, in one embodiment, provides information from the one or more games relative to regulations being tested in the one or more games in a way that a manager may be able to determine progress in learning the regulations tested in the one or more games.

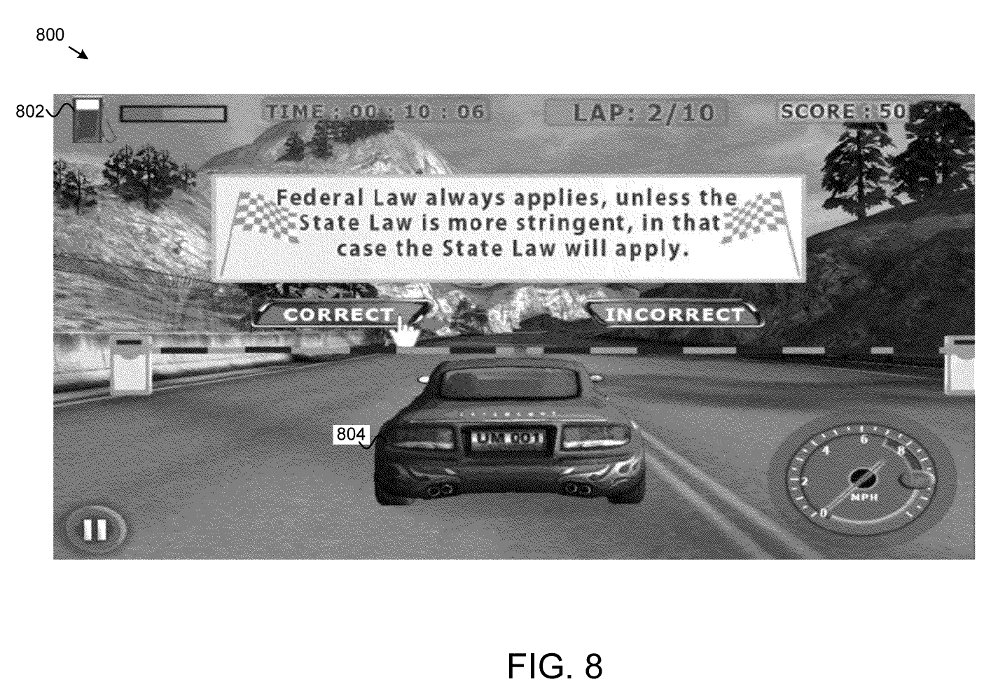

FIG. 8 is an illustration depicting one example of a game 800 associated with a regulation. In one example, the game may be a racing game. A goal of the racing game may be to progress around a track one or more times as quickly as possible. In one embodiment, the display module 205 presents a rear view of a race car 804. In another embodiment, the display module 205 presents a dashboard view from within the race car 804, as if the user is driving the race car 804. In this example, a gamification feature may include gasoline 802 for a car in the racing game. Therefore, in response to a correct response by a user, the user may be awarded additional gasoline 802. The amount of gasoline 802 awarded to the user may depend on a difficulty of the question.

For example, a beginning question that is answered correctly may result in a gallon of gasoline 802 being awarded to the user, whereas, an advanced question that is answered correctly may result in five gallons of gasoline 802 being awarded to the user. In another example, a correct response may increase speed of a car in the racing game, may unlock a feature, such as a mechanism to slow other cars, provide tools useful to the driver, etc. The racing game may include checkpoints, where a user may be required to response to additional questions based on the associated regulation. In one example, successive correct responses may result in an increased speed for the user's car in the racing game. In certain embodiments, the racing game is played on a virtual race track, a country road, a cross country race, or the like.

In another example, the virtual learning environment may include a plurality of race cars 804 in the racing game. Each race car 804 may represent another user. Respective users may answer their own questions whereby, the users may race each other in the racing game. In another embodiment, the race cars are divided into teams that race against each other. In such an embodiment, players on a team can help each other answer regulation questions, give others at least a portion of their gas, or the like. The display module 205 may display a current status of each of the cars in the racing game. Also, a reporting module 360 may display results from each of the cars in the racing game, such as other players' scores, average speeds, or the like.

In one example, the racing game may be played real-time. In another example, a user may pause the game. In response to a user pausing the game, the gaming module 210 may store a current position of the user's car. In response to the user continuing a saved game, the gaming module 210 may load the last saved position of the user's car. In another example, the location of the race may include a cross-country drive, driving down a country road, driving through a busy city street, or the like.

According to FIG. 8, a display module 205 may present an amount of gas, a number of laps, a current position on the track, a current score, a current question or challenge, other graphical components, such as, but not limited to, the car, a speedometer, tires, scenery, or the like.

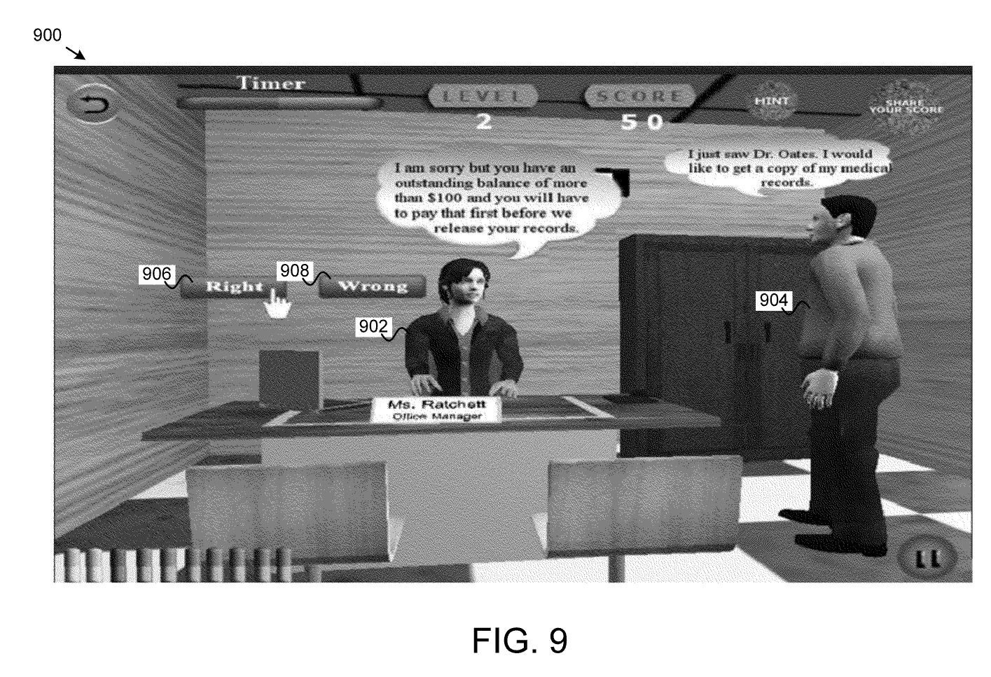

FIG. 9 is an illustration depicting one example of a game 900 tailored to a specific workplace. In one example, a regulation interaction module 335 may present an interaction scenario to the user, the interaction including a virtual presentation of a scenario where the user interacts with a virtual character in compliance with a regulation associated with the industry sector. In one example, the regulation interaction module 335 may present a medical secretary 902 and a patient 904. The patient 904 may request his medical records, and the medical secretary 902 may provide a response. A user of the game may select whether the response by the medical secretary conforms to a regulations associated with the game. In certain embodiments, a character's 902, 904 title (e.g., secretary, office manager, doctor, or the like) is displayed in response to user input, such as hovering over a character with a mouse cursor, or the like.

The user may select “Right” 906 if the user believes the response to be in compliance with the regulation. The user may select “Wrong” 908 if the user believes the response to not be in compliance with the regulation. The regulation interaction module 335 may present additional questions based on the scenario and associated with other regulations associated with the industry sector. In one example, the display module 205 may present a timer for the game, a level of the game, a difficulty of the game, a score for the user, other buttons as described herein, other graphical components, such as, but not limited to, a desk, an office, other people, or other items to generate a familiarity with a workplace scenario, or the like.

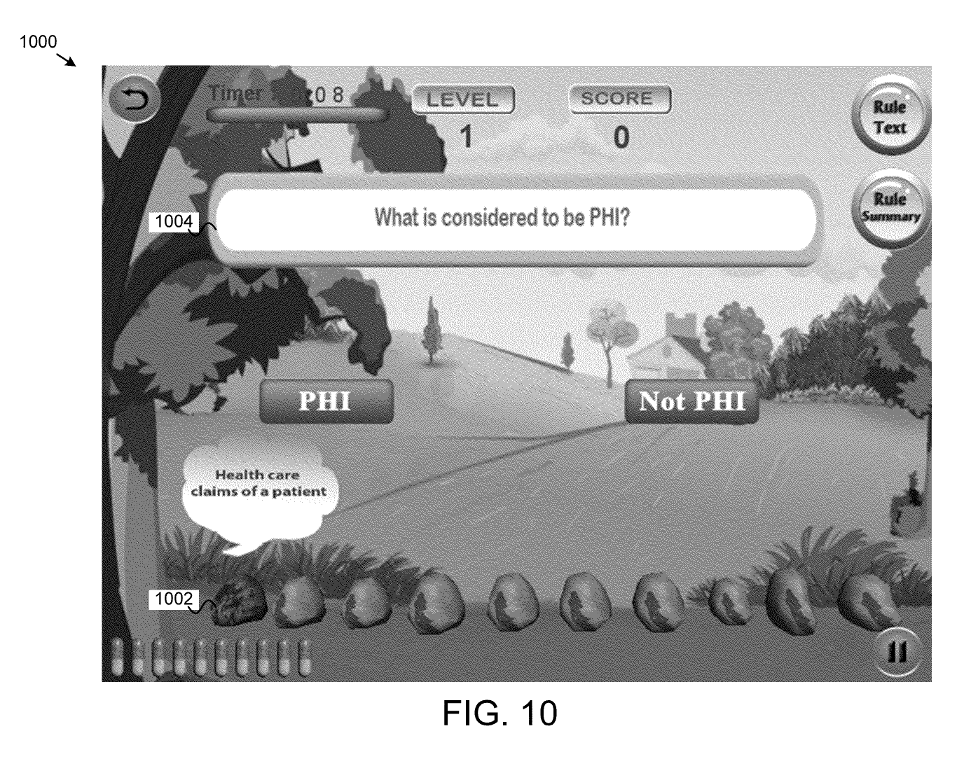

FIG. 10 is an illustration depicting one example of a game 1000 associated with a regulation. In one example, a regulation compliance module 315 may present a compliance scenario that includes a rock garden. In response to the user clicking on one of the rocks 1002, the regulation compliance module 315 may present a question 1004 associated with a regulation to the user. In response to a correct response, the rock may transform into a flower. In response to an incorrect response, the rock may transform into a weed.

As with previous examples, in one example, the display module 205 may present a timer for the game, a level of the game, a difficulty of the game, a score for the user, other buttons as described herein, other graphical components, such as, but not limited to, a field, a tree, or other items that may be aesthetically pleasing to the user, but may or may not have a role in the scenario.

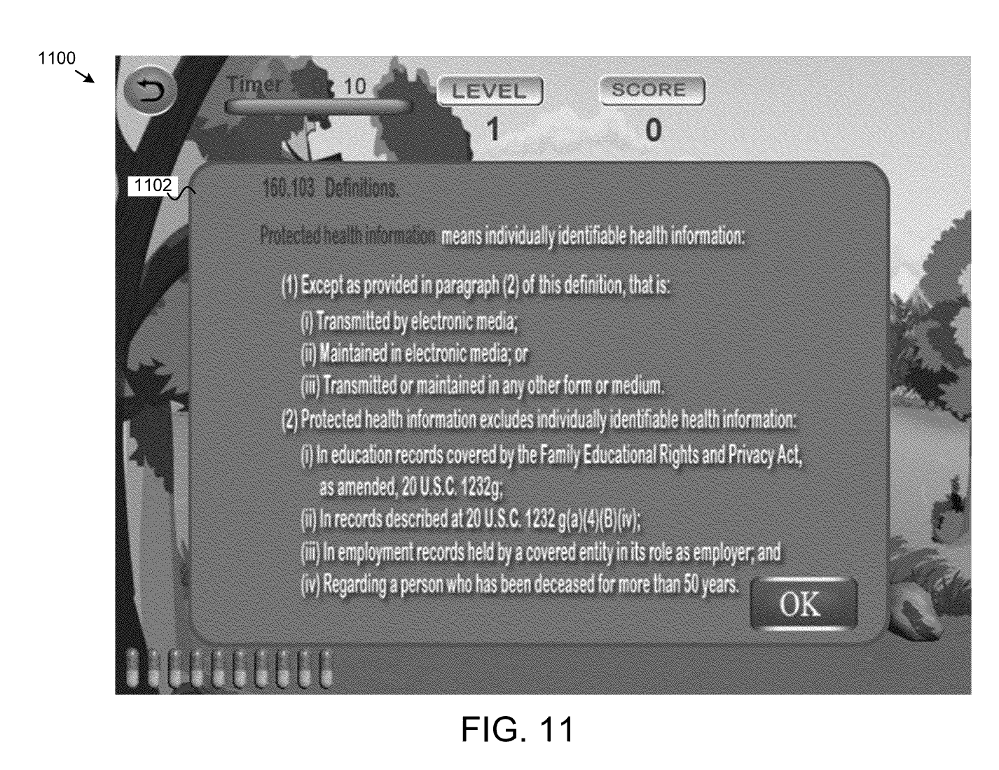

FIG. 11 depicts one embodiment of an interface 1100 for displaying the text 1102 of a regulation associated with a game. In certain embodiments, a library module 375 presents the text of a regulation in response to user input. For example, in response to a user clicking on a button presented by the library module 375, the library module 375 may present the text of a regulation. In certain embodiments, as part of a game, the scoring module 345 tracks the number of times a user requests to see the text of a regulation, which may be incorporated into the scoring of the game. For example, a user may lose points if he requests the text of a regulation more than three times, or the like. Alternatively, the library module 375 may present a summary and/or interpretation of the regulation instead of the regulation text, which may make the regulation easier to learn, understand, and/or the like.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a display module that presents a virtual learning environment on an electronic display of an electronic device, wherein the virtual learning environment is for an organization associated with an industry sector;
a gaming module that presents a game within the virtual learning environment, the game designed to one or more of train and test a user on regulations associated with the industry sector; and
a management module that provides a manager access to the game, the manager being different than the user, wherein the manager accesses one or more game settings to customize the game according to the skill level of the user.

2. The apparatus of claim 1, wherein the gaming module further comprises:
a regulation non-compliance module that presents a non-compliance scenario in the game, the non-compliance scenario comprising a virtual presentation of a scenario that violates a regulation associated with the industry sector; and
a non-compliance score module that receives a response from the user and scores the received response, wherein the user recognizing the violation of the regulation comprises a higher score than the user not recognizing the violation.

3. The apparatus of claim 1, wherein the gaming module further comprises:
a regulation compliance module that presents a compliance scenario in the game, the compliance scenario comprising a virtual presentation of a scenario that demonstrates compliance with a regulation associated with the industry sector; and
a compliance score module that receives a response from the user and scores the received response, wherein the user recognizing the compliance with the regulation comprises a higher score than the user not recognizing the compliance.

4. The apparatus of claim 1, wherein the gaming module further comprises:
a regulation task module that presents a task scenario in the game, the task scenario comprising a virtual presentation of a scenario where the user one or more of performs a virtual task in compliance with a regulation and takes one or more virtual actions to make a scenario compliant with a regulation, the regulation associated with the industry sector; and
a task score module that receives a response from the user and scores the received response, wherein one or more of the user performing the virtual task in compliance with the regulation and the user taking one or more virtual actions to make a scenario compliant with the regulation comprises a higher score than one or more of the user not performing the virtual task in compliance with the regulation and the user not taking one or more virtual actions to make the scenario compliant with the regulation.

5. The apparatus of claim 1, wherein the gaming module further comprises:
a regulation interaction module that presents an interaction scenario in the game, the interaction scenario comprising a virtual presentation of a scenario where the user interacts with a virtual character in compliance with a regulation associated with the industry sector; and
an interaction score module that receives a response from the user and scores the received response, wherein the user interacting with the virtual character in compliance with the regulation comprises a higher score than the user not interacting in compliance with the regulation.

6. The apparatus of claim 1, further comprising a scoring module that determines a score for the game based on the user's performance in the game, the score being accessible to the manager of the game.

7. The apparatus of claim 1, wherein the one or more game settings comprise game content and game rules, a manager adjusting one or more of the game content and game rules based on the user's performance in the game.

8. The apparatus of claim 1, further comprising a reporting module that creates a report based on the user's scores associated with the game, wherein the report is organized by regulations presented in the game.

9. The apparatus of claim 1, wherein the display module presents a representation of a workplace location, the workplace location representing a role in the organization and having one or more games tailored to the role.

10. The apparatus of claim 9, wherein the one or more games are played in sequence and increase in difficulty in response to the user successfully playing a game.

11. The apparatus of claim 1, wherein the gaming module modifies one or more game settings in response to the user playing the game such that the user is provided with a different experience each time the game is played.

12. The apparatus of claim 1, further comprising a gamification module that provides one or more gamification features for the game, the one or more gamification features comprising virtual life, achievements, leaderboards, and virtual currency.

13. The apparatus of claim 1, further comprising a certification module that provides a certification associated with the industry sector to the user in response to the user successfully playing a game associated with the industry sector.

14. The apparatus of claim 1, wherein the gaming module increases a difficulty of the game in response to a correct response from the user, and wherein the gaming module decreases a difficulty of the game in response to an incorrect response from the user.

15. The apparatus of claim 1, wherein the gaming module manages a competition between a plurality of users playing the game, the plurality of users being grouped into a plurality of teams, a team score being generated by combining individual scores of the plurality of users on a team.

16. The apparatus of claim 1, further comprising a help module that connects the user with a remote user in response to user input, the remote user providing the user with information regarding one or more of the regulations.

17. The apparatus of claim 1, further comprising a library module that presents one of a text of a regulation, a summary of a regulation, and an interpretation of a regulation to the user in response to user input.

18. A method comprising:
presenting a virtual learning environment on an electronic display of an electronic device, wherein the virtual learning environment is for an organization associated with an industry sector;
presenting a game within the virtual learning environment, the game designed to one or more of train and test a user on regulations associated with the industry sector; and
providing a manager access to the game, the manager being different than the user, wherein the manager accesses one or more game settings to customize the game according to the skill level of the user.

19. The method of claim 18, further comprising:
presenting a non-compliance scenario in the game, the non-compliance scenario comprising a virtual presentation of a scenario that violates a regulation associated with the industry sector; and
receiving a response from the user and scoring the received response, wherein the user recognizing the violation of the regulation comprises a higher score than the user not recognizing the violation.

20. The method of claim 18, further comprising:
presenting a compliance scenario in the game, the compliance scenario comprising a virtual presentation of a scenario that demonstrates compliance with a regulation associated with the industry sector; and
receiving a response from the user and scoring the received response, wherein the user recognizing the compliance with the regulation comprises a higher score than the user not recognizing the compliance.

21. The method of claim 18, further comprising:
presenting a task scenario in the game, the task scenario comprising a virtual presentation of a scenario where the user one or more of performs a virtual task in compliance with a regulation and takes one or more virtual actions to make a scenario compliant with a regulation, the regulation associated with the industry sector; and
receiving a response from the user and scoring the received response, wherein one or more of the user performing the virtual task in compliance with the regulation and the user taking one or more virtual actions to make a scenario compliant with the regulation comprises a higher score than one or more of the user not performing the virtual task in compliance with the regulation and the user not taking one or more virtual actions to make the scenario compliant with the regulation.

22. The method of claim 18, further comprising:
presenting an interaction scenario in the game, the interaction scenario comprising a virtual presentation of a scenario where the user interacts with a virtual character in compliance with a regulation associated with the industry sector; and
receiving a response from the user and scoring the received response, wherein the user interacting with the virtual character in compliance with the regulation comprises a higher score than the user not interacting in compliance with the regulation.

23. The method of claim 18, further comprising presenting a representation of a workplace location, the workplace location representing a role in the organization and having one or more games tailored to the role, wherein the one or more games are played in sequence and increase in difficulty in response to the user successfully playing a game.

24. The method of claim 18, further comprising modifying one or more game settings in response to the user playing the game such that the user is provided with a different experience each time the game is played.

25. A program product comprising a computer readable storage medium that stores code executable by a processor to perform:
presenting a virtual learning environment on an electronic display of an electronic device, wherein the virtual learning environment is for an organization associated with an industry sector;
presenting a game within the virtual learning environment, the game designed to one or more of train and test a user on regulations associated with the industry sector; and
providing a manager access to the game, the manager being different than the user, wherein the manager accesses one or more game settings to customize the game according to the skill level of the user.
